(19) United States
(12) Patent Application Publication
(10) Pub. No.: US 2011/0231820 A1
(43) Pub. Date: Sep. 22, 2011

(54) EXCLUSIVE LOGGING

(75) Inventor: Prashant UPADHYAYA, Gurgaon (IN)

(73) Assignee: ARICENT INC., George Town (KY)

(21) Appl. No.: 12/727,841

(22) Filed: Mar. 19, 2010

(51) Int. Cl. G06F 9/44; G06F 9/45; G06F 3/048

(52) U.S. Cl. 717/124; 717/140; 715/771

(57) ABSTRACT

Methods and systems are disclosed for controlled processing of a plurality of log statements. In an embodiment, the method includes accessing a database of unique identifiers for each of the log statements. The unique identifiers are generated based at least on a file name and a line number corresponding to each of the log statements. The method also includes determining a status corresponding to each of the unique identifiers. The status represents either an “on” or an “off” status of the log statements associated with each of the unique identifiers. The one or more of the log statements are processed based on the status of each of the log statements.

### FIELD OF THE INVENTION

This invention generally relates to exclusive logging of statements in a code. More particularly, the invention relates to a system and method for exclusive logging of statements on a per-file and a per-line basis.

### BACKGROUND OF THE INVENTION

Typical software coding and testing applications involve numerous instances where a user (coder or developer) may want to perform a controlled execution of a code. Examples of such scenarios include, by way of example, generating log reports, creating demo versions of given software, and selective execution of portions of the code, etc. This can be accomplished by a plurality of macros suitably placed in the code and selectively turning “ON” one or more of the macros.

Controlled execution of a code is typically implemented during a debugging process to generate log reports corresponding to a code. Log reports are usually not required and hence the log statements are turned off by the developer during normal course of a program execution. Existing logging system typically comprises a set of macros which an application calls from the corresponding code. The macro's are so used that the application does not have to pass file name and line number as additional parameters. A compiler can attach file name and line number during the expansion of the macro during the preprocessing, if the macro is suitably implemented. Such a logging system has pre-defined log levels and can distinguish macros based on the log levels.

The user can specify one or more log levels that need to be turned “ON” at the time of debugging and implement a controlled execution of log statements. However, there may be scenarios where a particular log level may have a large number of log statements. In such scenarios, when the user turns “ON” a particular log level, all the log statements of that particular log level get turned on at one go. This has implications on tracing ability and the performance of the application when the log statements are turned on.

There may be cases when the user wants to debug a particular usecase where it is required to obtain a trace from a particular function. The trace corresponds to a particular log level. The user turns “ON” the log level at the runtime to generate a log report. Since, the log level corresponding to the trace may have a large number of log statements, the log report will not only include the intended log but also a large number of undesirable log entries.

In the above use case, the situation can lead to unwanted consequences. An overwhelming amount of data may be collected for analysis. This can also lead to a storage issue in case of multi-hour runs. A more severe side effect is on the performance of the application. In extreme cases, the application may not even be able to retain its intended behavior because of severe performance penalty incurred due to turning on of the large number of logs. This might result into a situation where the application no longer is in a state where the user can debug the original issue which was intended to be traced and debugged.

Hence, it is desirable to perform controlled execution of macros with the finest possible granularity

### SUMMARY OF THE INVENTION

Embodiments of the present invention are directed to a method for controlled processing of a plurality of log statements. In an embodiment, the method includes accessing a database of unique identifiers for each of the plurality of log statements. The unique identifiers are generated based at least in part on a file name and a line number corresponding to each of the log statements. The method also includes determining a status corresponding to each of the unique identifiers. The status represents either an “on” or an “off” status of the log statements associated with each of the unique identifiers. The method further includes processing one or more of the plurality of log statements based on the determined status of each of the log statements.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings in which:

FIG. 1 schematically illustrates an example embodiment of a system for controlled processing of one or more log statements in a program code according to an embodiment.

FIG. 2 schematically illustrates an embodiment of exclusive logging module.

FIG. 3 illustrates an exemplary embodiment of a database generated by exclusive logging module at runtime.

FIG. 4 illustrates a method for controlled processing of a plurality of log statements according to an embodiment.

### DETAILED DESCRIPTION OF THE INVENTION

Conventional logging systems allow a developer to define log-levels that can be turned on or off at runtime. When a level is turned on, all the logs/traces of that level get turned on and likewise when the level is turned off, all the logs of the particular get turned off. Such a feature gives some flexibility to the developer to decide what should be logged at runtime. However, as described earlier, when a level is turned on, all the logs/traces of that level get turned on even though some of them are not required by the developer. This results in higher CPU utilization as well as requires additional resources to collect the data for analysis. The CPU utilization is a key issue because sometimes the usecase cannot be debugged because the number of logs that get turned on by turning on a particular level are so many that the runtime environment cannot afford to successfully turn on that level.

A solution to the above identified problem is to allow the developer to control the execution of log statements to the finest level of granularity. The finest level of granularity is achieved by controlling the execution of the log statements on a per-line and a per-file basis. Such a control needs the line number and file name information corresponding to a log which is readily provided by pre-processor directives available in standard C/C++ compilers (e.g. _FILE_ AND _LINE_). The existing logging system does not achieve the per-line and per-file control because of its fundamental paradigm of the control based on the log levels.

The disclosed control mechanism can co-exist with the conventional log level control and thus provides the developer with an option to switch between the two modes of control.

Disclosed methods and systems provide the capability to enable or disable trace/logging statements in the code on a per file-name and line-number basis. By way of example, the developer can choose exactly the set of traces which he needs at runtime to the finest possible granularity of a single trace statement. Typical scenarios where this would be useful includes but not limiting to debugging where the usecase to be debugged is running at a very high CPU load and all or a ‘set’ of logs cannot be turned on, yet the developer wants to turn on a few exclusive set of logs without producing a new build. The disclosed method also gives opportunity to reduce spam traces while debugging usecases over long periods of runs. In addition, the implementation of the per-line and per-file based control is independent of the type of processor and the operating system used and can be implemented in different environments.

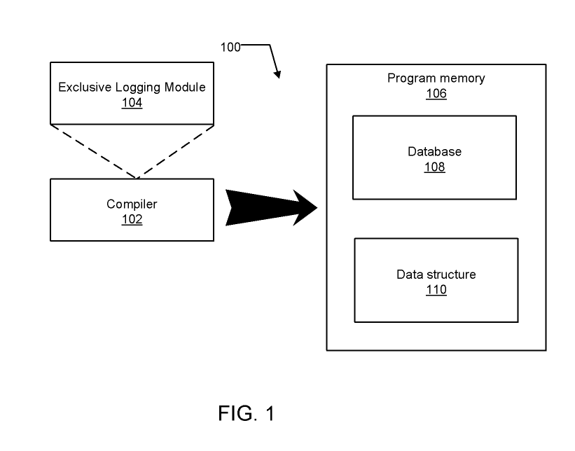

FIG. 1 illustrates an embodiment of a system environment 100 for controlled processing of a plurality of log statements. Accordingly, the system environment 100 includes a compiler 102 configured to transform a source code written in a computer language (the source language) into another computer language (the target language, often having a binary form known as object code).

The “compiler” 102 may also refer to set of instructions that translate source code from a high-level programming language to a lower level language (e.g., assembly language or machine code). It may be appreciated that in addition to the ongoing description, the compiler 102 may perform one or more of the operations, such as, lexical analysis, preprocessing, parsing, semantic analysis, code generation, and code optimization. The complier 102 may also correspond to C/C++ compiler.

In an exemplary embodiment, the compiler 102 includes an exclusive logging module 104 implements a controlled execution of log statements or macros in a code. Although, the exclusive logging module 104 has been shown as a part of the compiler 102, it may be noted that the exclusive logging module 104 may be implemented as a separate module outside of the compiler 102. In addition, the exclusive logging module 104 may also correspond to code logic or a set of instructions when executed implements the disclosed exclusive logging on a per-file and a per-line basis. The compiler 102 accesses a program memory 106 to create, store, and query a database 108. In particular, the compiler 102 generates unique identifiers based at least in part on a file name and a line number corresponding to each of the log statements. A standard feature of C/C++ compiler is the pre-processing directive that captures the file name and line number corresponding to a given log statement. The compiler 102 creates the database 108 at runtime to capture and store the unique identifiers thus generated. In operation, the compiler 102 accesses the database 108 at runtime to determine a status corresponding to each of the unique identifiers. The status represents either an “on” or an “off” status of the log statements associated with each of the unique identifiers stored in the database 108. The compiler 102 creates the database 110 to store the status information of the log statements. The compiler 102 processes one or more of the log statements based on the status of each of the log statements.

The compiler 102 provides a runtime facility to change the markings of ON/OFF in the data structure 110. The user has the flexibility to turn the logs on and off at runtime without restarting the application. The compiler 102 uses such macros at suitable places in the code depending on the way the code needs to be traced at runtime. The implementation of the macros ensures that the application need not pass the file name and the line number. The macro implementation uses the C compiler's _FILE_ and _LINE_ preprocessor directives to automatically generate file name and line number for each log statement. The execution of the macro produces the output (file name and line number) in addition to the log string generated and traced by the application using arguments such as, printf, etc. The compiler 102 also creates a data structure 110 at runtime that represents either an “ON” or “OFF” status corresponding to log statements in the program code.

In a conventional logging system, consider 4 log levels—CRITICAL, ERROR, WARNING and INFO. Further, assume that the logging system provides the following macro's to the applications:—

LOG_CRITICAL (“<printf like format string>”, < . . . printf like variable arguments>)

LOG_ERROR

LOG_WARNING

LOG_INFO

It is to be noted that the arguments to the macros are the same in each case as indicated in LOG_CRITICAL. The application can use these macros at suitable places in the code to generate trace reports at runtime. In addition, existing logging system maintains a data structure at runtime, which informs the logging system about a particular level that is currently set as “ON”. For example, the logging system can maintain a mapping like the following:—

CRITICAL—ON

ERROR—ON

WARNING—OFF

INFO—OFF

This is also referred to as “self level”. Each time a log macro comes in the execution path, the macro code checks whether the self-level (e.g. LOG_CRITICAL) is marked “ON” or “OFF” in the data structure. If the data structure has “OFF” marked for the level, then the macro code simply returns without doing any further processing. If the data structure has “ON” marked for the level, then the macro code goes ahead and constructs the output string with other information like file name, line number, timestamp etc. and outputs it on a suitable device (e.g. a console).

By way of example, consider a use case where an application has a total of 1000 log statements in the code. Also, consider further that all of the log statements are coming in the execution path of the code at runtime. Also, assume that there are 100 CRITICAL level logs, 200 ERROR level logs, 300 WARNING level logs and 400 INFO level logs. To begin with, all the log levels are marked OFF. These logs, all put together, are distributed all over the code inside several functions. Now, suppose a user wants to debug a particular usecase to obtain a trace from a particular function. It is identified that the trace is present in a log statement which has been coded at the INFO level. Therefore, the obvious thing to do is to turn the INFO level “on” at the runtime by using the facility available. Now as soon as this is done, the trace under interest will start coming out. However, there is a possible undesirable side effect of doing the same. As soon as the user turns the INFO level “on”, he will not only get his intended log, which was at INFO level, but also all the info level logs which are coming in the execution path of the application. In the ongoing example usecase, there are 400 such log statements.

In the above use case, the situation can lead to unfortunate consequences. First, an overwhelming amount of data may be collected for analysis. This can prove to be a storage issue in case of multi-hour runs. Further, it can prove to be an analysis issue with large amount of data collected. In the above example, the amount of data collected would be four hundred times the data which was needed to be collected by the user.

A more severe side effect is on the performance of the application. The application may not even be able to retain its intended behavior because of severe performance penalty incurred due to turning on of the 400 logs. This might lead to a situation where the application no longer is in a state where the user can debug the original issue which was intended to be traced and debugged, when the INFO level is turned “on” as per the above usecase.

### Design of the Exclusive Logging System:

Given the above scenario, the fundamental problem is to control the turning “on” and “off” of individual log statements. The concept of log levels of the conventional logging system proves to be insufficient in this regard. The disclosed exclusive logging module 104 shown in FIG. 1 provides a solution that enables a user to control the turning on and off of individual log statements based on a combination of file name and line number associated with a particular log statement which is unique to that log statement.

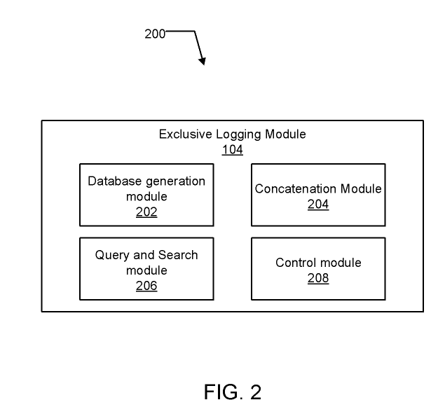

FIG. 2 illustrates an embodiment of exclusive logging module 104. Accordingly, the exclusive logging module 104 includes a database generation module 202 configured to store unique identifiers (e.g. a combination of file name and line number). The compiler 102, at runtime, generates the unique identifiers for each of the log statements based on the file name and the line number corresponding to a given log statement.

The unique identifiers represent a unique log level for each log statement, without the application having to specify that on their own. Such an identifier should be a DNA footprint of the log statement. In an exemplary implementation, the unique identifier correspond to a combination of the file name and the line number represented by that log statement. Every log statement is present in a particular file at a particular line number. The combination of these two data elements forms a composite key which is unique for all the logs present in an application. The combination can be used as an implicit log level to control the turning “on” and “off” of the log statements. Also, such an implicit level need not be added by an application when they code new log statements, because logs will naturally be coded in some file name at some line number and this combination will always be different from all the other log statements already present. Further, the filename and line number is available to the log macro via the compiler 102 (e.g. C/C++ compiler).

Given this combination, the compiler 102, in addition to the conventional (log-level based) ON/OFF marking data structure, discussed above, also generates the data structure 110. An instance of the data structure 110 according to an embodiment can look like a table with the following columns:—

| File Name | Line Number | ON/OFF Status |
|---|---|---|
| Abm.c | 50 | ON |
| Pdm.c | 49 | OFF |
| Bgp.c | 50 | OFF |

The data structure 110 has the composite unique key of the first two columns and the on/off status in the third column.

When such a data structure 110 is present at runtime, then when every log statement comes in the execution path, it simply compares the self-filename and the self-line number (the log macro knows its own file name and line number), with the mapping present in the data structure 110 to check if it is marked ON or OFF. The remaining business logic of the generation of the log string remains the same as earlier. In an exemplary embodiment, the exclusive logging module 104 injects the unique information about file names and line numbers inside an image from the compiler 102.

### Injection of File Name and Line Number Combination

As discussed earlier, a conventional logging system has access to the file name and line number of the log statement because the log statement is a macro. The implementation of macro definition takes advantage of the following two preprocessor directives of the C compiler
1. _FILE_—this represents, in the form of a string, the filename which is being compiled.
2. _LINE_—this is a number, in the form of an integer, for the line number which is being compiled.

The exclusive logging module 104 utilizes the above two directives to inject the information into a specific area in the memory which can subsequently be utilized to construct the database 108 and data structure 110 as described earlier.

It may be appreciated by a person skilled in the art that the above two directives are available at compile time, so the database cannot be trivially constructed since the code is getting compiled and not executed. The exclusive logging module 104 uses these directives in the code so that the resulting executable has the information about file names and line numbers. When the code execution starts, exclusive logging module 104 can look up this injected data and construct the required database 108 and the data structure 110.

The objective of the exclusive logging module 104 is to gather records of file names and line numbers from the compiler 102. The constant strings for an application in a C code goes into a particular section of the resulting executable image. For example, if a piece of code has a constant string char* foo=“hello world”, the “hello world” string goes into the (.const) section of the resulting executable image which has a standard format (e.g. the ELF format). Depending on the compiler and the options used, such a section maybe different from .const section, for example, may be the .text section, but for the purpose of ongoing description, the .const section has been considered. However, it may be noted that the concept is applicable to other sections too.

Now, the exclusive logging module 104 can generate the _FILE_ constant string in the code with the macro. But the string _FILE_ is the same for all the log statements in a particular file. Further, the directive _LINE_ is not a constant string at all. In an implementation, the exclusive logging module 104 generates a constant string is combination of _FILE_ and _LINE_. For example, if FILE represents “abm.c” and LINE represents the number 30, then the exclusive logging module 104 generates a constant string “abm.c:30” or, for a better lookup later, a constant string like “elog:abm.c:30”. The token elog can be added so that the string is unique from all the other constant strings present otherwise in the code. This helps in identification of the exclusive logging related strings which help in the construction of the database 108 and the data structure 110.

The exclusive logging module 104 includes a concatenation module 204 configured to concatenate the string “elog” with the content of FILE and with the content represented by _LINE_. The concatenation module 204 uses the “#” operator of the C/C++ preprocessor.

In other words, the log statement's macro implementation is such that it uses the “#” operator to concatenate the contents of the FILE and LINE to produce a unique constant string in the macro—“elog:<filename>:<linenumber>”.

Since the above is done on a per log statement basis, the compiler 102 generates as many constant strings as the number of log statements it compiles. All these strings are randomly scattered in the .const section of the resultant executable image.

By way of example, the usage of the # operator can be as follows:

#define XSTR(x,y) “elog:” #y “:” x

#define XAPPEND(x,y) XSTR(x,y)

Now, if the log macro, in the current implementation, refers to XAPPEND as follows: XAPPEND (_FILE_, _LINE_) and _LINE_ evaluates to 30 and _FILE_ evaluates to “abm.c”, then the XAPPEND will evaluate to the string “elog:abm.c:30”. The string thus generated will go into the .const section of the resulting image. The same will be true for all the log statements with their corresponding filenames and line numbers.

### Runtime Construction and Management of Database

The exclusive logging module 104 constructs the database of mapping as described earlier. The construction of the database needs to be done at the runtime. The generated strings, representing records of file names and line numbers for each log statement, as described above, are present in the .const area already. The objective of the exclusive logging module 104 is to build an organized database of these records at the initialization of the application from the randomly distributed string records in the .const section.

To achieve the construction of the database, it may be noted that though the strings are randomly scattered in the .const section, each string possesses a virtual address in the address space of the resulting process at the runtime. Using this virtual address, the string is accessible. However, the code does not know this virtual address because it is not stored in any variable and the log statement generated the strings but could not assign it to any global variable within the macro. This was because the macro was generic for all the log statements.

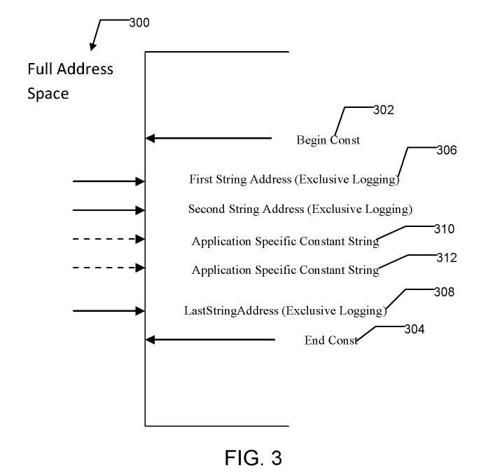

However, it is known that the strings are thrown in the .const section. The virtual address of the beginning and end of the .const section can be obtained from the readelf utility which can inspect an executable after compilation and linking. Further, the compiler 102 generates global variable names using which the beginning and end of various sections of the executable can be traversed including the .const section. Depending on the compiler and the options used, such a section maybe different from .const section, for example, may be the .text section, but for the purpose of ongoing description, the .const section has been considered. However, it may be noted that the concept is applicable to other sections too. FIG. 3 illustrates an exemplary embodiment of the .const database (section) 300 generated by exclusive logging module 104 at runtime. As shown in FIG. 3, the full address space will include the virtual addresses of all the entries in the .const area.

For illustration purposes, let the global variables be “BeginConst” 302 and “EndConst” 304. BeginConst 302 represents the virtual address of the start of the .const section 300 and the EndConst 304 represents the virtual address of the end of the .const section 300. It is therefore clear, that although the strings could lie anywhere inside the .const section, their starting addresses have to be within the BeginConst 302 and EndConst values 304.

At the application startup, the exclusive logging module 104 runs a loop that traverses from the BeginConst 302 to the EndConst 304. The exclusive logging module 104 also includes a query and search module 206 configured to perform a search at each address to test whether the string of interest to exclusive logging (beginning with “elog” token) is present or not. The query and search module 206 takes note of the virtual address of the first string present. Likewise a search is performed till the EndConst address and the address of the beginning of the last string of interest to exclusive logging is recorded. For purposes of description, the addresses will be referred to as FirstStringAddress 306 and LastStringAddress 308.

Now, in the process of scanning the .const section for checking the presence of the “elog” strings, the query and search module 206 identifies that the starting address of all the exclusive log related strings are between the FirstStringAddress 306 and LastStringAddress 308. Next, the exclusive logging module 104 builds a data structure or a sparse Bitmap array (not shown) containing as many bits as the numerical value of FirstStringAddress 306 subtracted from LastStringAddress 308.

For instance, if the LastStringAddress value is 50000 and the FirstStringAddress is 4000, then the bitmap will have 50000−4000=46000 bits. The bitmap will be a character buffer big enough to hold as many bits.

It may be noted that in the bitmap, the first bit will represent logically the FristStringAddress 306, the second bit will represent the address FirstStringAddress+1 (this is not the second string address), . . . , and the last bit will represent the LastStringAddress. In addition, the bitmap is a sparse bitmap because certain bits are representing addresses which do not hold the exclusive logging related strings at all. For example, as shown in FIG. 3, the .const area 300 may include application specific constant strings 310 and 312. However, some bits at least in the bitmap represent addresses in the .const section holding the exclusive logging related strings. The exclusive logging module 104 initializes each bit in the bitmap to zero in the beginning.

If the bit in this bitmap is set to one, and if that bit represents an exclusive log string, it means that the corresponding log statement as per the file name and line number present in that string is marked ON. Likewise, if the bit in this bitmap is set to zero, and if that bit represents an Exclusive Log string, it means that the corresponding log statement as per the file name and line number present in that string is marked OFF.

In addition, if the bit in the bitmap does not represent an exclusive log string, then it does not matter if the value is zero or not.

The exclusive logging module 104 includes a control module 208 configured to handle the management of the database at runtime and thereafter. The control module 208 performs two main operations as required by the utility which will let the user exercise control over the logs on a per file and a per line basis. Firstly, the control module 208 provides an option to the user to enable or disable a particular log statement. Secondly, the control module 208 provides the user with an option to query, which log statements are enabled/disabled.

For the first option, the user provides the system 100 with the file name and the line number of the log that needs to be enabled or disabled. Once the system 100 knows the file name and line number, the exclusive logging module 104 runs a loop from FirstStringAddress 306 to LastStringAddress 308 parsing all the encountered exclusive log strings and checks if any one of them contains the same filename and line number which the user has provided. If the match is found, the control module 208 notes the address of that exclusive log string. For purposes of illustration, this address is referred to as “TargetAddress”. The value of FirstStringAddress 306 subtracted from the value of TargetAddress represents the bit number offset in the bitmap which holds the bit corresponding to the current exclusive log string. The corresponding bit is accessed in the bitmap. If it is an enable operation, the control module 208 sets the bit (marked to 1 or turns it ON). If it is a disable operation, the control module 208 unsets the bit (marked to 0 or turn it OFF)

In the second option, the user may want to find out which file names and line numbers are enabled for exclusive logging. To service such a query or command, the exclusive logging module 104 runs a loop from FirstStringAddress 306 to LastStringAddress 308 parsing all the encountered Exclusive Log strings. For each encountered string, the TargetAddress is noted. The bit number offset is calculated for this TargetAddress. It is checked if this bit is set or unset. If it is set, then it is reported to the user that the corresponding file name and line number is turned ON as an exclusive log. If the bit is unset, then nothing is reported to the user. Thus, only those log statements are reported which are marked ON.

In an implementation, the exclusive logging module 104 optimizes the lookup from the log macro into the database 108. The optimization aspect has a direct bearing on the performance of exclusive logging system 100 at run time. The database 108 will have as many entries as there are log statements in the application. In a typical application, the number of entries can run into thousands. Each log macro which comes into the execution path has to find out whether its own level i.e. its own combination of file name and line number is ON or OFF. Clearly, a simple linear search will make the runtime operation of the log macro sub-optimal from the perspective of performance. In conventional logging systems, the look-up was done only on a few levels and hence it was not expensive.

Optimal Lookup into Database

It may be noted that the log macro (and the exclusive logging module 104) has access to the exclusive logging string as a pointer. The macro notes this string pointer as TargetAddress. This string pointer will lie between the First String Address 306 and the LastStringAddress 308. The value of FirstStringAddress 306 is subtracted from TargetAddress. The resultant value is the bit number offset in the bitmap described earlier. The exclusive logging module 104 checks if this bit is set or not. If the bit is set, then the log statement is turned on and further processing is done by the macro to output the log statement. If the bit is not set, then the macro assumes that this log statement is not turned on and does not generate the log and simply returns.

It may be appreciated that the design of the database 108 is such that it is an inexpensive lookup into the database by the log macro to find out whether the log statement is turned on or not. It is not a linear search for file name and line number into the database 108. It is important that the log macro be as efficient as possible to determine whether it is enabled or not. Majority of the times when the debugging is not enabled, the macro quickly determines that the log statement is turned off and stops any further processing. If the macro does any linear search of a large database to determine whether it is turned on or off, then it affects the performance of the application.

It may also be noted that the mechanism of searching in the scheme of exclusive logging includes computation of a bit number offset which is a straightforward mathematical operation of subtracting the FirstStringAddress 306 from TargetAddress. To check whether the bit in the bitmap is set or not is also an inexpensive operation. It entails the computation of the correct character location within the bitmap buffer array and then a masking operation to find out whether the bit within the corresponding character is set or not.

Coexistence of Exclusive Logging with Conventional Logging

In an exemplary embodiment, exclusive logging can be incrementally implemented on top of conventional logging systems. The default paradigm, for example, can be conventional logging which is controlled via the runtime log levels. The user can then enter into the exclusive logging mode where the existing levels are not checked, but the logic of exclusive logging kicks in at the runtime. This can be controlled via. a global variable in the application.

The combination provides for an advantage of selective modes of logging selectable by a user because exclusive logging is a more specialist usage. It is more useful for some precise operations on a heavily loaded setup where conventional logs cannot be turned on. Further, to use exclusive logging, the user has to be aware of the file names and line numbers where the relevant log statements are present.

Although, the systems and methods have been described in the context of logging systems, it will be appreciated by those skilled in the art that the principle of exclusive logging can be implemented in any scenario where a per-file and per-line control is desirable. For example, one such scenario may be creating a demo version of a software code. The developer can place macros in the code in such a manner that the execution of certain parts of the code can be activated for a limited number of times or a time frame.

Several creative solutions can be built which can mix and match the conventional logging log levels and the abilities of the exclusive logging to provide efficient services to the user. (E.g., the user may want all the CRITICAL level logs and the remaining logs to be exercised via exclusive logging control).

### Exemplary Method:

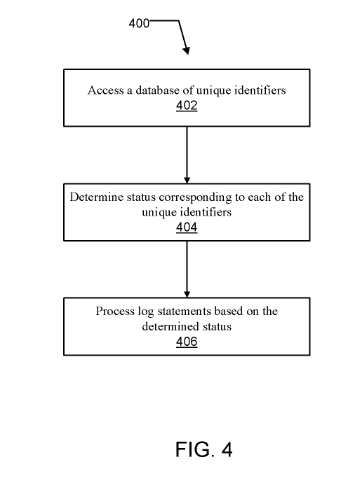

FIG. 4 illustrates a method 400 for controlled processing of a plurality of log statements according to an embodiment.

At block 402, a database of unique identifiers is accessed. In an implementation, the exclusive logging module 104 accesses the database 108 of unique parameters for each of the many log statements in the application code. The unique identifiers are generated based at least in part on a file name and a line number corresponding to each of the log statements.

At block 404, a status corresponding to each of the unique identifiers is determined. In an implementation, the exclusive logging module 104 determines the “on”: or “off” status of the log statements associated with each of the unique identifiers.

At block 406, one or more of the plurality of log statements are processed based on the determined status of each of the log statements. The exclusive logging module 104 processes (executes) the macros or the log statements to a value and generates a corresponding output.

In an alternative embodiment, the method 400 also includes determination of the file name and the line number corresponding to each of the log statement during compilation. As discussed earlier, the pre-processor directives enable such a determination. The method 400 also the step of concatenation of the file name and the line number with identification token (e.g. “elog”) to generate the unique identifiers for each of the log statements. The concatenation module uses the “#” commands to accomplish this. The concatenated strings are stored in the database 108.

The method 400 also includes the step of creation of a sparse bitmap array storing values representing the status of the log statement. The exclusive logging module 104 generates a data structure 110 (e.g. sparse bitmap array) that stores either “1” or a “0” to represent an “off” or “on” status of the log statement.

The method further includes the step of computation of an offset value for each of the unique identifiers based on virtual addresses of the unique identifiers in the database 108.

The exclusive logging module 104 accesses the sparse bitmap array (data structure 110) based on the offset value to determine the status corresponding to each of the unique identifiers.

### Considerations for Memory Requirements

As will be appreciated by those skilled in the art, there will be incremental memory requirements for implementing the exclusive logging. Consider an application with N log statements. For each log statement, the compiler 102 generates the following exclusive logging string:—

“elog:<filename>:<line number>”→E.g. “elog:abm.c:5000”

Also, assume the average filename size to be 20 characters and the maximum line number is 6 digits. This gives an entire string length of 33 characters. For a total of N logs, the bytes required to store these strings in the .const area would be N times 33. If, for example, there are 50,000 log statements in the system, the number of bytes required would be 50000*33=1650000 or approximately 1.65 Megabytes.

The data structure required by the system 100 for exclusive logging is the bitmap which represents whether the corresponding log statement is turned on or not. The number of bits in the bitmap is not only dependent on the number of log statements in the code, but also on how these are scattered by the compiler in the .const section. It is to be noted that the exclusive log strings are not the only strings present in the .const area but other constant strings of the application are also placed in the same section.

However, practically an embedded application may not use a heavy number of constant strings. Therefore, in most of the cases, the exclusive logging strings may make up for the majority of the strings. Suppose the number of other constant strings is 100% of the number of exclusive logging strings. If there are 50,000 log statements in the database 108, then there are 50,000 other constant strings of similar size empirically based on the above supposition. Thus, in the worst case the difference between the LastStringAddress and the StartStringAddress will be 50000*33+50000*33=3300000. Thus, in the example case, a total of 3300000 bits or 412500 bytes (approximately 403 Kilobytes) will be required to manage the bitmap.

Altogether, for an application having 50,000 logs, we need around 1.65 Megabytes+0.4 Megabytes=approximately 1.7 Megabytes. Assuming that as a policy, one log statements is added per 10 lines of code, 50,000 log statements implies an application source lines of around 500000. The management of the .const area is done by the compiler 102 that can handle any other data structure based on the described principle of a per-file and per-line control. Depending on the size of the application, the bitmap can be statically allocated with a, say, 25% larger size than what is required so that when additional logs and constant strings get added in the code, the bitmap size need not be changed each time.

Systems and methods for exclusive logging are typically advantageous on setups with high load where logs cannot be turned on easily at a particular log level without disturbing the behavior of the usecase itself. In addition, it can coexist with the conventional logging system and is almost non-intrusive at runtime with conventional logging till it is exercised. One of the advantages of exclusive logging system is that it is independent of the type of operating system and processor. However, as discussed earlier, the systems and methods require a compiler which has a preprocessor and has support for preprocessor directives for file names and line number described earlier (e.g. may not work with Java compiler since it doesn't have a preprocessor). Exclusive logging system reduces the turnaround time in debugging in heavily loaded setups as well as in fielded setups where a particular use case is live and needs to be tracked, but it is too risky for operations to turn on a particular log level. In an implementation, the system 100 can be implemented with PQ processor using OSE Operating System and gcc, DSP processor using OSEck Operating System and CCS compiler and Cavium Octeon processor using Linux Operating System and gcc.

It will be appreciated that the teachings of the disclosed invention can be implemented as a combination of hardware and software. The software is preferably implemented as an application program comprising a set of program instructions tangibly embodied in a computer readable medium. The application program is capable of being read and executed by hardware such as a computer or processor of suitable architecture. Similarly, it will be appreciated by those skilled in the art that any examples, flowcharts, functional block diagrams and the like represent various exemplary functions, which may be substantially embodied in a computer readable medium executable by a computer or processor, whether or not such computer or processor is explicitly shown. The processor can be a Digital Signal Processor (DSP) or any other processor used conventionally that is capable of executing the application program or data stored on the computer-readable medium.

The example computer-readable medium can be, but is not limited to, (Random Access Memory) RAM, (Read Only Memory) ROM, (Compact Disk) CD or any magnetic or optical storage disk capable of carrying application program executable by a machine of suitable architecture. It is to be appreciated that computer readable media also includes any form of wired or wireless transmission. Further, in another implementation, the method in accordance with the present invention can be incorporated on a hardware medium using ASIC or FPGA technologies.

It is to be appreciated that the subject matter of the claims are not limited to the various examples an language used to recite the principle of the invention, and variants can be contemplated for implementing the claims without deviating from the scope. Rather, the embodiments of the invention encompass both structural and functional equivalents thereof.

While certain present preferred embodiments of the invention and certain present preferred methods of practicing the same have been illustrated and described herein, it is to be distinctly understood that the invention is not limited thereto but may be otherwise variously embodied and practiced within the scope of the following claims.

1. A method for controlled processing of a plurality of log statements, the method comprising:
accessing a database of unique identifiers for each of the plurality of log statements, the unique identifiers being generated based at least in part on a file name and a line number corresponding to each of the log statements;
determining a status corresponding to each of the unique identifiers, the status representing either an “on” or an “off” status of the log statements associated with each of the unique identifiers; and
processing one or more of the plurality of log statements based on the determined status of each of the log statements.

2. The method as in claim 1, wherein the method further comprises:
determining the file name and the line number corresponding to each of the log statement during compilation;
concatenating the file name and the line number with an identification token to generate the unique identifiers for each of the plurality of the log statements; and
storing the unique identifiers in the database.

3. The method as in claim 1, wherein the method further comprises creating a sparse bitmap array storing values representing the status of the log statement.

4. The method as in claim 3, wherein the determining comprises:
computing an offset value for each of the unique identifiers based on virtual addresses of the unique identifiers in the database; and
accessing the sparse bitmap array based on the offset value to determine the status corresponding to each of the unique identifiers.

5. A system for controlled processing of one or more log statements in a program code, the system comprising:
an exclusive logging module configured to identify and process a log statement from the one or more log statements based at least in part on a combination of plurality of unique parameters associated with the log statement, the plurality of unique parameters comprising a file name and a line number associated with the log statement.

6. The system as claimed in claim 5, wherein the system further comprises a database configured to create and maintain, at run-time, the unique parameters corresponding to each of the plurality of log statements.

7. The system as claimed in claim 5, wherein the unique parameters correspond to a log level associated with each of the log statements.

8. The system as claimed in claim 5, wherein the exclusive logging module is configured to present a user-interface to enable a user to specify the one or more of the plurality of unique parameters.

9. The system as claimed in claim 5, wherein the exclusive logging module is configured to process the log statement if the parameters associated with the log statement corresponds to an “on” status.

10. The system as claimed in claim 5, wherein the controlled processing is independent of processor type.

11. The system as claimed in claim 5, wherein the controlled processing is independent of type of operating system.

12. The system as claimed in claim 5, wherein the exclusive logging module corresponds to a sub-module in a C/C++ compiler.

13. An exclusive logging system, the system comprising:
a data structure configured to represent, at runtime, either an ‘on’ or an ‘off’ status corresponding to a log statement in a program code, the representation based at least in part on a combination of a line number and a file name associated with the log statement; and
a compiler configured to access the data structure and execute the log statement based at least in part on the status.

14. The exclusive logging system as in claim 13, wherein the exclusive logging system further comprises a database configured to create, maintain, and look-up, at run-time, the file name and the line number corresponding to the log statement.

15. The exclusive logging system as in claim 13, wherein the log statement corresponds to a macro.

16. The exclusive logging system as in claim 13, wherein the log statement corresponds to a macro for generation of log or trace reports.

17. The exclusive logging system as in claim 13, wherein the compiler is configured to present a user interface that enables a user to set the ‘on’ or ‘off’ state at runtime by specifying the file name and the line number corresponding to the log statement.

18. The exclusive logging system as in claim 13, wherein the program compiler is configured to present a user interface that enables a user to query the status of the log statement.

19. The exclusive logging system as in claim 13, wherein the representation is based at least in part on a combination of one or more of: a log level, the line number, and the file name associated with the log statement.

20. The exclusive logging system as in claim 14, wherein the compiler is configured to execute a macro that concatenates the file name and the line number with identification token to generate a unique identifier.
